(19) United States
(12) Patent Application Publication
(10) Pub. No.: US 2020/0364510 A1
(43) Pub. Date: Nov. 19, 2020

(54) NETWORK ENGINE FOR INTELLIGENT PASSIVE TOUCH RESOURCE ANALYSIS

(71) Applicant: Bank of America Corporation, Charlotte, NC (US)

(72) Inventors: Joseph Benjamin Castinado, North Glenn, CO (US); Kapil Chhibber, Davis, CA (US); Catherine Ann Crepps, Mooresville, NC (US); John Allen Sellers, Kennett Square, PA (US)

(73) Assignee: Bank of America Corporation, Charlotte, NC (US)

(21) Appl. No.: 16/414,130

(22) Filed: May 16, 2019

(51) Int. Cl. G06K 9/62; G07C 5/08; G06F 16/909; G06F 16/9035; G06N 20/00; H04L 9/32

(52) U.S. Cl. CPC G06K 9/6262; G07C 5/0841; H04L 9/3234; G06F 16/9035; G06N 20/00; G06F 16/909

(57) ABSTRACT

Embodiments of the invention are directed to a system, method, or computer program product for intelligent passive touch network engine for resource touch misappropriation mitigation. In this way, the invention utilizes a multi-faceted resource decisioning machine learning application integration as data deployment across a built out passive touch network engine for deployment and integration for passive touch misappropriation identification. The passive touch network performs artificial intelligent pattern trends, locations, usages, and the like to determine potential misappropriation via supplemental resources. This is a deviation from standard data based misappropriation prevention based on utilization of supplemental resources as misappropriation identification.

### BACKGROUND

Present conventional systems do not have the capability to passively identify misappropriation occurrences. Currently, manual or computer based misappropriation identification occurs actively at a conversion point. As such, there exists a need for a system to perform passive touch resource tracking.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address these and/or other needs by providing an innovative system, method and computer program product for intelligent passive touch resource analysis. In this way, the system piggybacks off of a network engine for multi-faceted resource decisioning to provide for an intelligent passive touch resource analysis. As such, providing a non-monetary or non-transactional misappropriation determination via supplemental resource.

Embodiments of the invention are directed to a system, method, or computer program product for intelligent passive touch network engine for resource touch misappropriation mitigation. In this way, the invention utilizes a multi-faceted resource decisioning machine learning application integration as data deployment across a built out passive touch network engine for deployment and integration for passive touch misappropriation identification. The passive touch network performs artificial intelligent pattern trends, locations, usages, and the like to determine potential misappropriation via supplemental resource. This is a deviation from standard data based misappropriation prevention based on utilization of supplemental resources as misappropriation predictors, as such, identifying third party benefits or programs and use that as a non-monitory misappropriation predictor.

Embodiments of the invention comprise a system, method, and computer program product for intelligent passive touch authentication, the invention comprising: identifying supplemental resources associated with a user; identifying, via artificial intelligence engine analysis, supplemental resource patterns for the user; monitoring, continually, user supplemental resource usage and update the supplemental resource usage based on the monitoring; triggering accessing the supplemental resource patterns based on an identification of a transaction utilizing a vehicle associated with the user; comparing the supplemental resource pattern data with the transaction utilizing the vehicle associated with the user; triggering misappropriation action based on no match between geographic location associated with the supplemental resource pattern data and the transaction utilizing the vehicle associated with the user; and blocking the transaction and processing the transaction until additional user multi-factor authentication completion.

In some embodiments, the invention further comprises allowing transaction processing based on a match between the supplemental resource pattern data and the transaction utilizing the vehicle associated with the user.

In some embodiments, comparing the supplemental resource pattern data with the transaction utilizing the vehicle associated with the user further comprising identifying a geographical location match between the supplemental resource pattern data and the transaction. In some embodiments, comparing the supplemental resource pattern data with the transaction utilizing the vehicle associated with the user further comprises comparing a geographic location, trend, or usage of the supplemental resources with the transaction.

In some embodiments, the invention further comprises creating a database of supplemental resource patterns for the user and user authorized associates.

In some embodiments, the supplemental resource patterns for the user further comprise locations, times, trends, and usage of the supplemental resources for the user.

In some embodiments, supplemental resources further comprise third party benefits, programs, and subscriptions available to the user including points, rewards, offers, subscription services, products, services associated with non-monetary benefits.

In some embodiments, identifying transaction utilizing vehicle associated with the user further comprises transactions using a payment vehicle associated with the user by the user, an authorized associate of the user, or a misappropriation of the payment vehicle.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a resource aggregation and deployment system environment, in accordance with one embodiment of the invention;

FIG. 2 provides a block diagram of a user device, in accordance with one embodiment of the invention;

FIG. 3 provides a block diagram of resource aggregation and deployment engine, in accordance with one embodiment of the invention;

FIG. 4 provides block diagram of an entity system, in accordance with one embodiment of the invention;

FIG. 5 provides a high level process flow illustrating resource aggregation and deployment, in accordance with one embodiment of the invention;

FIG. 6 provides an intelligent passive touch resource network engine integration within a resource aggregation and deployment system environment, in accordance with one embodiment of the invention;

FIG. 7 provides a high level process flow illustrating network engine deployment for passive touch resource analysis, in accordance with one embodiment of the invention; and

FIG. 8 provides a high level process flow illustrating passive touch resource analysis and misappropriation identification, in accordance with one embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

As used herein, the term “user” may refer to any entity or individual associated with the resource aggregation engine and system disclosed herein. In some embodiments, a user may be a computing device user, a phone user, a mobile device application user, a customer of an entity or business, a financial institution customer (e.g., an account holder or a person who has an account (e.g., banking account, credit account, or the like)), and/or employee of an entity. In a specific embodiment, a user may be a customer accessing a resource stored in a resource location via an associated user device. In another specific embodiment, a user operates, employs, or otherwise uses a known resource, wherein the resource aggregation engine identifies and automatically implements for the user one or more additional known resources and/or unknown resources for the user. In some embodiments, identities of an individual may include online handles, usernames, identification numbers (e.g., Internet protocol (IP) addresses), aliases, family names, maiden names, nicknames, or the like. In some embodiments, the user may be an individual or an organization (i.e., a charity, business, company, governing body, or the like).

As used herein the term “user device” may refer to any device that employs a processor and memory and can perform computing functions, such as a personal computer or a mobile device, wherein a mobile device is any mobile communication device, such as a cellular telecommunications device (i.e., a cell phone or mobile phone), a mobile Internet accessing device, or other mobile device. Other types of mobile devices may include laptop computers, tablet computers, wearable devices, cameras, video recorders, audio/video player, radio, global positioning system (GPS) devices, portable digital assistants (PDAs), pagers, mobile televisions, gaming devices, or any combination of the aforementioned. The device may be used by the user to access the system directly or through an application, online portal, internet browser, virtual private network, or other connection channel.

As used herein, the term “resource” may refer to a computing resource, electronic data, or an exchangeable currency having a value (e.g., funds) or the like. A computing resource may refer to elements of one or more computing devices (e.g., processor, memory, communication device, and the like) networks, or the like available to be used in the execution of tasks or processes. A computing resource may be used to refer to available processing, memory, and/or network bandwidth and/or power of an individual computing device as well a plurality of computing devices that may operate as a collective for the execution of one or more tasks (e.g., one or more computing devices operating in unison). As used herein, a “resource location” may refer to a location for storage of one or more resources. A resource storage location may include an account (e.g., a savings or check account) or a data storage location (e.g., a datastore or memory device). As used herein, a “resource vehicle” may refer to any medium for resource conveyance from one resource location to another. For example, a resource vehicle may comprise a credit or debit card, a check, a wire transfer, a gift card, or the like. In one embodiment, a resource vehicle may comprise a data transfer mechanism or device (e.g., a thumb drive or other removable data storage).

As used herein, an “interaction” or “connection” may refer to any communication between one or more users, one or more entities or institutions, and/or one or more devices or systems within the system environment described herein. For example, an interaction may refer to a transfer or exchange of resources (e.g., data, information, funds, and the like) between systems, devices, and/or application; an accessing of stored data by one or more devices; a transmission of a requested task; a sharing or leveraging of resources (e.g., computing resources) between device; or the like. An interaction may include user interactions with a user interface (e.g., clicking, swiping, text or data entry, and the like), authentication actions (e.g., signing-in, username and password entry, PIN entry, and the like), account actions (e.g., account access, fund transfers, and the like) and the like. In a specific embodiment, an “interaction” may refer to a resource transfer executed between one or more users and/or entities (e.g., a transaction).

As used herein, the term “entity” may be used to include any organization or collection of users that may interact with the resource aggregation engine and system. An entity may refer to a business, company, or other organization that either maintains or operates the system or requests use and accesses the system. The terms “financial institution” and “financial entity” may be used to include any organization that processes financial transactions including, but not limited to, banks, credit unions, savings and loan associations, investment companies, stock brokerages, asset management firms, insurance companies and the like. In specific embodiments of the invention, use of the term “bank” is limited to a financial entity in which account-bearing customers conduct financial transactions, such as account deposits, withdrawals, transfers and the like. In other embodiments, an entity may be a business, organization, a government organization or the like that is not a financial institution. In a specific embodiment, an entity is a resource providing entity such as a financial institution that provides a resource vehicle and/or location (e.g., a credit card and associated account) to a user. The resource vehicle and/or location may include supplementary resources.

As used herein, “authentication information” may refer to any information that can be used to identify a user. For example, a system may prompt a user to enter authentication information such as a username, a password, a personal identification number (PIN), a passcode, biometric information (e.g., voice authentication, a fingerprint, and/or a retina scan), an answer to a security question, a unique intrinsic user activity, such as making a predefined motion with a user device. This authentication information may be used to at least partially authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system.

To “monitor” is to watch, observe, or check something for a special purpose over a period of time. The “monitoring” may occur periodically over the period of time, or the monitoring may occur continuously over the period of time. In some embodiments, a system may actively monitor a data source, database, or data archive, wherein the system reaches out to the database and watches, observes, or checks the database for changes, updates, and the like. In other embodiments, a system may passively monitor a database, wherein the database provides information to the system and the system then watches, observes, or checks the provided information. In some embodiments a system, application, and/or module may monitor a user input in the system. In further embodiments, the system may store said user input during an interaction in order to generate a user interaction profile that characterizes regular, common, or repeated interactions of the user with the system. In some embodiments, “monitoring” may further comprise analyzing or performing a process on something such as a data source either passively or in response to an action or change in the data source.

A “transaction” or “resource distribution” refers to any communication between a user and the financial institution or other entity to transfer funds for the purchasing or selling of a product. A transaction may refer to a purchase of goods or services, a return of goods or services, a payment transaction, a credit transaction, or other interaction involving a user's account. In the context of a financial institution, a transaction may refer to one or more of: a sale of goods and/or services, initiating an automated teller machine (ATM) or online banking session, an account balance inquiry, a rewards transfer, an account money transfer or withdrawal, opening a bank application on a user's computer or mobile device, a user accessing their e-wallet, or any other interaction involving the user and/or the user's device that is detectable by the financial institution. A transaction may include one or more of the following: renting, selling, and/or leasing goods and/or services (e.g., groceries, stamps, tickets, DVDs, vending machine items, and the like); making payments to creditors (e.g., paying monthly bills; paying federal, state, and/or local taxes; and the like); sending remittances; loading money onto stored value cards (SVCs) and/or prepaid cards; donating to charities; and/or the like.

In various embodiments, the point-of-transaction device (POT) may be or include a merchant machine and/or server and/or may be or include the mobile device of the user may function as a point of transaction device. The embodiments described herein may refer to the use of a transaction, transaction event or point of transaction event to trigger the steps, functions, routines and the like described herein. In various embodiments, occurrence of a transaction triggers the sending of information such as alerts and the like. As used herein, a “bank account” refers to a credit account, a debit/deposit account, or the like. Although the phrase “bank account” includes the term “bank,” the account need not be maintained by a bank and may, instead, be maintained by other financial institutions. For example, in the context of a financial institution, a transaction may refer to one or more of a sale of goods and/or services, an account balance inquiry, a rewards transfer, an account money transfer, opening a bank application on a user's computer or mobile device, a user accessing their e-wallet or any other interaction involving the user and/or the user's device that is detectable by the financial institution. As further examples, a transaction may occur when an entity associated with the user is alerted via the transaction of the user's location. A transaction may occur when a user accesses a building, uses a rewards card, and/or performs an account balance query. A transaction may occur as a user's mobile device establishes a wireless connection, such as a Wi-Fi connection, with a point-of-sale terminal. In some embodiments, a transaction may include one or more of the following: purchasing, renting, selling, and/or leasing goods and/or services (e.g., groceries, stamps, tickets, DVDs, vending machine items, and the like); withdrawing cash; making payments to creditors (e.g., paying monthly bills; paying federal, state, and/or local taxes and/or bills; and the like); sending remittances; transferring balances from one account to another account; loading money onto stored value cards (SVCs) and/or prepaid cards; donating to charities; and/or the like.

In some embodiments, the transaction may refer to an event and/or action or group of actions facilitated or performed by a user's device, such as a user's mobile device. Such a device may be referred to herein as a “point-of-transaction device”. A “point-of-transaction” could refer to any location, virtual location or otherwise proximate occurrence of a transaction. A “point-of-transaction device” may refer to any device used to perform a transaction, either from the user's perspective, the merchant's perspective or both. In some embodiments, the point-of-transaction device refers only to a user's device, in other embodiments it refers only to a merchant device, and in yet other embodiments, it refers to both a user device and a merchant device interacting to perform a transaction. For example, in one embodiment, the point-of-transaction device refers to the user's mobile device configured to communicate with a merchant's point of sale terminal, whereas in other embodiments, the point-of-transaction device refers to the merchant's point of sale terminal configured to communicate with a user's mobile device, and in yet other embodiments, the point-of-transaction device refers to both the user's mobile device and the merchant's point of sale terminal configured to communicate with each other to carry out a transaction.

In some embodiments, a point-of-transaction device is or includes an interactive computer terminal that is configured to initiate, perform, complete, and/or facilitate one or more transactions. A point-of-transaction device could be or include any device that a user may use to perform a transaction with an entity, such as, but not limited to, an ATM, a loyalty device such as a rewards card, loyalty card or other loyalty device, a magnetic-based payment device (e.g., a credit card, debit card, and the like), a personal identification number (PIN) payment device, a contactless payment device (e.g., a key fob), a radio frequency identification device (RFID) and the like, a computer, (e.g., a personal computer, tablet computer, desktop computer, server, laptop, and the like), a mobile device (e.g., a smartphone, cellular phone, personal digital assistant (PDA) device, MP3 device, personal GPS device, and the like), a merchant terminal, a self-service machine (e.g., vending machine, self-checkout machine, and the like), a public and/or business kiosk (e.g., an Internet kiosk, ticketing kiosk, bill pay kiosk, and the like), a gaming device, and/or various combinations of the foregoing.

In some embodiments, a point-of-transaction device is operated in a public place (e.g., on a street corner, at the doorstep of a private residence, in an open market, at a public rest stop, and the like). In other embodiments, the point-of-transaction device is additionally or alternatively operated in a place of business (e.g., in a retail store, post office, banking center, grocery store, factory floor, and the like). In accordance with some embodiments, the point-of-transaction device is not owned by the user of the point-of-transaction device. Rather, in some embodiments, the point-of-transaction device is owned by a mobile business operator or a point-of-transaction operator (e.g., merchant, vendor, salesperson, and the like). In yet other embodiments, the point-of-transaction device is owned by the financial institution offering the point-of-transaction device providing functionality in accordance with embodiments of the invention described herein.

Further, the term “payment credential” or “payment vehicle,” as used herein, may refer to any of, but is not limited to refers to any of, but is not limited to, a physical, electronic (e.g., digital), or virtual transaction vehicle that can be used to transfer money, make a payment (for a service or good), withdraw money, redeem or use loyalty points, use or redeem coupons, gain access to physical or virtual resources, and similar or related transactions. For example, in some embodiments, the payment vehicle is a bank card issued by a bank which a user may use to perform purchase transactions. However, in other embodiments, the payment vehicle is a virtual debit card housed in a mobile device of the user, which can be used to electronically interact with an automated teller machine (ATM) or the like to perform financial transactions. Thus, it will be understood that the payment vehicle can be embodied as an apparatus (e.g., a physical card, a mobile device, or the like), or as a virtual transaction mechanism (e.g., a digital transaction device, digital wallet, a virtual display of a transaction device, or the like).

In some embodiments, information associated with the purchase transaction is received from a POT including a point-of-sale (POS) terminal during a transaction involving a consumer and a merchant. For example, a consumer checking out at a retail merchant, such as a grocer, may provide to the grocer the one or more goods or products that he is purchasing together with a payment method, loyalty card, and possibly personal information, such as the name of the consumer. This information along with information about the merchant may be aggregated or collected at the POS terminal and routed to the system or server of the present invention or otherwise a third party affiliate of an entity managing the system of this invention. In other embodiments when the purchase transaction occurs over the Internet, the information associated with the purchase transaction is collected at a server providing an interface for conducting the Internet transaction. In such an embodiment, the consumer enters product, payment, and possibly personal information, such as a shipping address, into the online interface, which is then collected by the server. The server may then aggregate the transaction information together with merchant information and route the transaction and merchant information to the system of the present invention. It will be further be understood that the information associated with the purchase transaction may be received from any channel such as an automated teller machine (ATM), Internet, peer-to-peer network, POS, and/or the like.

The invention further comprises an industry partnership between financial institutions, merchants, armored carriers, and governmental agencies to digitize the cash supply chain. This invention includes a set of standards to apply the same supply chain logistics and tools that the retail, health care, food service and many other industries have used to drive package/product handling efficiencies and reduce overall costs and issues to the cash supply chain.

Further, the term “supplemental resource,” as used herein, may refer to any third party benefits, programs, subscriptions, or the like available to a user, such as points, rewards, offers, subscription services, products, services, and the like associated with monitory and non-monetary benefits. This may include television subscriptions, gym memberships, magazine subscriptions, rewards points for entities or payment vehicles, entity loyalty programs, or the like.

Many users have accounts that include rewards or third party benefits associated with the use and activation of the account. These may be credit cards with rewards, frequent shopper rewards, memberships, or the like. When users are planning around spend, specifically for a larger multi-faceted purchase (where multiple sub-divisions or sub spends are made, such as planning for a vacation (flight, hotel, rental car, dinning, or the like)) it is difficult for the user to identify the best path forward using one or more of those accounts to maximize the benefits across the board. Once multiple facets are in play, the decisioning gets complex (4 or 5 airlines, 4 or 5 major hotel brands, 4 or 5 rental car companies, and the like). The system provides an engine that allows for frictionless user data ingestion for linking all of the user accounts and associated rewards. The engine may leverage information about the user's next purchase and leverage artificial intelligence (AI) and machine learning models to provide the user with a series of options that bridge together the optimization of spend/rewards. This may also include monitoring of stocks and the like that the user possesses and buy/sell of those based on trends.

Furthermore, the system may also link various other users to identify similar users to further predict the best option based on like users. In order to determine the appropriate option, the system may, over time, provide a valuation to each option. The system may continually look to see what reward/benefit is the best by placing a valuation on the reward and aggregate it across the various options the user has in order to provide the most value. Creating an inventory of “next best” options for the user. The platform provides a cross linkage to entity programs in providing a holistic view of user plans for purchasing. The system may also provide automatic enrollment into third party benefits the user may not be aware of to further maximize the options and rewards for the user. Finally, the system may link with merchants to connect information about the user to drive the user to the merchant and/or provide additional benefits to the user if determined user is shopping with merchant using corporate card or other non-entity card to ensure user gets the rewards.

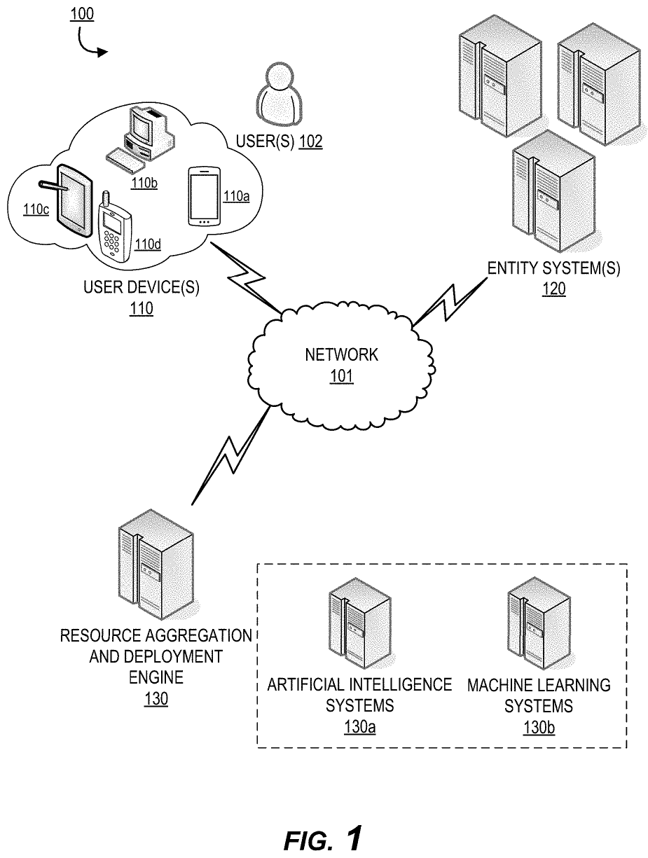

FIG. 1 provides a resource aggregation engine system environment 100, in accordance with one embodiment of the invention. As illustrated in FIG. 1, resource aggregation and deployment engine or system 130 is operatively coupled, via a network 101, to the user device(s) 110 (e.g., a plurality of user devices 110a-110d) and the entity system(s) 120. In this way, the resource aggregation and deployment engine 130 can send information to and receive information from the user device 110 and the entity system 120. In the illustrated embodiment, the plurality of user devices 110a-110d provide a plurality of communication channels through which the entity system 120 and/or the resource aggregation and deployment engine 130 may communicate with the user 102 over the network 101.

In the illustrated embodiment, the resource aggregation and deployment engine 130 further comprises an artificial intelligence (AI) system 130a and a machine learning system 130b which may be separate systems operating together with the resource aggregation and deployment engine 130 or integrated within the resource aggregation and deployment engine 130.

FIG. 1 illustrates only one example of an embodiment of the system environment 100. It will be appreciated that in other embodiments, one or more of the systems, devices, or servers may be combined into a single system, device, or server, or be made up of multiple systems, devices, or servers. It should be understood that the servers, systems, and devices described herein illustrate an embodiment of the invention. It is further understood that one or more of the servers, systems, and devices can be combined in other embodiments and still function in the same or similar way as the embodiments described herein.

The network 101 may be a system specific distributive network receiving and distributing specific network feeds and identifying specific network associated triggers. The network 101 may also be a global area network (GAN), such as the Internet, a wide area network (WAN), a local area network (LAN), or any other type of network or combination of networks. The network 101 may provide for wireline, wireless, or a combination wireline and wireless communication between devices on the network 101.

In some embodiments, the user 102 is an individual interacting with one or more entity systems 120 via a user device 110 while a data flow between the user device 110 and the entity system 120 is intercepted and monitored by the resource aggregation and deployment engine 130 over the network 101. In some embodiments a user 102 is a user requesting service from the entity or interacting with an account maintained by the entity system 120. In an alternative embodiment, the user 102 is an individual interacting with the resource aggregation and deployment engine 130 over the network 101 and authorizing input of user resources and information from the entity systems 120 to the resource aggregation and deployment engine 130 for processing and analysis.

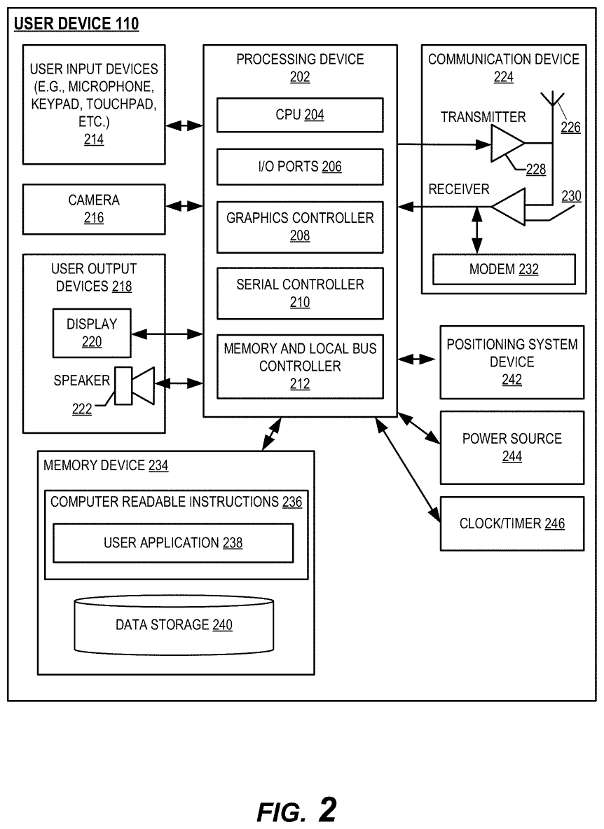

FIG. 2 provides a block diagram of a user device 110, in accordance with one embodiment of the invention. The user device 110 may generally include a processing device or processor 202 communicably coupled to devices such as, a memory device 234, user output devices 218 (for example, a user display device 220, or a speaker 222), user input devices 214 (such as a microphone, keypad, touchpad, touch screen, and the like), a communication device or network interface device 224, a power source 244, a clock or other timer 246, a visual capture device such as a camera 216, a positioning system device 242, such as a geo-positioning system device like a GPS device, an accelerometer, and the like. The processing device 202 may further include a central processing unit 204, input/output (I/O) port controllers 206, a graphics controller or graphics processing device (GPU) 208, a serial bus controller 210 and a memory and local bus controller 212.

The processing device 202 may include functionality to operate one or more software programs or applications, which may be stored in the memory device 234. For example, the processing device 202 may be capable of operating applications such as the user application 238. The user application 238 may then allow the user device 110 to transmit and receive data and instructions from the other devices and systems of the environment 100. The user device 110 comprises computer-readable instructions 236 and data storage 240 stored in the memory device 234, which in one embodiment includes the computer-readable instructions 236 of a user application 238. In some embodiments, the user application 238 allows a user 102 to access and/or interact with other systems such as the entity system 120. In some embodiments, the user is a customer of a financial entity and the user application 238 is a resource management application providing access to a resource location maintained by the entity system 120 wherein the user may interact with a resource location via a user interface of the user application 238.

The processing device 202 may be configured to use the communication device 224 to communicate with one or more other devices on a network 101 such as, but not limited to the entity system 120 and the resource aggregation and deployment engine 130. In this regard, the communication device 224 may include an antenna 226 operatively coupled to a transmitter 228 and a receiver 230 (together a “transceiver”), modem 232. The processing device 202 may be configured to provide signals to and receive signals from the transmitter 228 and receiver 230, respectively. The signals may include signaling information in accordance with the air interface standard of the applicable BLE standard, cellular system of the wireless telephone network and the like, that may be part of the network 201. In this regard, the user device 110 may be configured to operate with one or more air interface standards, communication protocols, modulation types, and access types. By way of illustration, the user device 110 may be configured to operate in accordance with any of a number of first, second, third, fourth, and/or fifth-generation communication protocols and/or the like. For example, the user device 110 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, with fifth-generation (5G) wireless communication protocols, and/or the like. The user device 110 may also be configured to operate in accordance with non-cellular communication mechanisms, such as via a wireless local area network (WLAN) or other communication/data networks. The user device 110 may also be configured to operate in accordance Bluetooth® low energy, audio frequency, ultrasound frequency, or other communication/data networks.

The user device 110 may also include a memory buffer, cache memory or temporary memory device operatively coupled to the processing device 202. Typically, one or more applications 238, are loaded into the temporarily memory during use. As used herein, memory may include any computer readable medium configured to store data, code, or other information. The memory device 234 may include volatile memory, such as volatile Random Access Memory (RAM) including a cache area for the temporary storage of data. The memory device 234 may also include non-volatile memory, which can be embedded and/or may be removable. The non-volatile memory may additionally or alternatively include an electrically erasable programmable read-only memory (EEPROM), flash memory or the like.

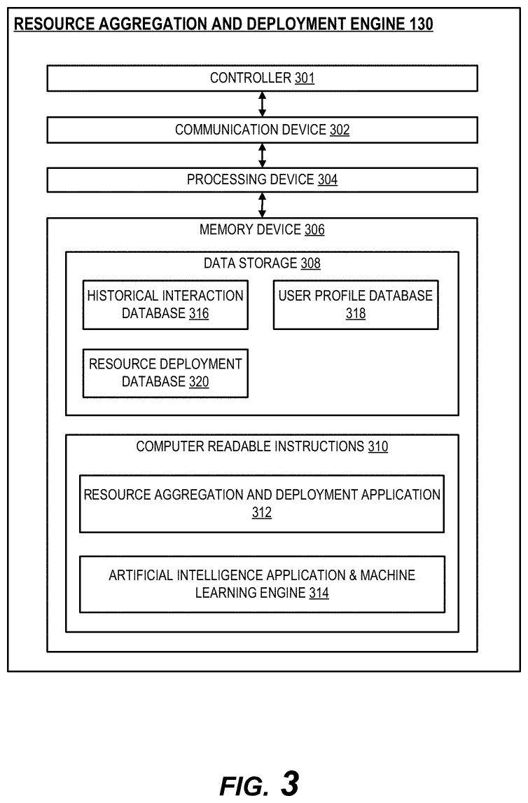

FIG. 3 provides a block diagram of a resource aggregation and deployment engine or system 130, in accordance with one embodiment of the invention. The resource aggregation and deployment engine 130 generally comprises a controller 301, a communication device 302, a processing device 304, and a memory device 306.

As used herein, the term “controller” generally refers to a hardware device and/or software program that controls and manages the various systems described herein such as the user device 110, the entity system 120, and/or the resource aggregation and deployment engine 130, in order to interface and manage data flow between systems while executing commands to control the systems. In some embodiments, the controller may be integrated into one or more of the systems described herein. In some embodiments, the controller may perform one or more of the processes, actions, or commands described herein.

As used herein, the term “processing device” or “processor” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 304 is operatively coupled to the communication device 302 and the memory device 306. The processing device 304 uses the communication device 302 to communicate with the network 101 and other devices on the network 101, such as, but not limited to the user device 110 and the entity system 120. As such, the communication device 302 generally comprises a modem, server, or other device for communicating with other devices on the network 101.

As further illustrated in FIG. 3, the resource aggregation and deployment engine 130 comprises computer-readable instructions 310 stored in the memory device 306, which in one embodiment includes the computer-readable instructions 310 of a resource aggregation and deployment application 312 and an artificial intelligence application 314 which further comprises a machine learning engine. In one embodiment, the artificial intelligence application 322 and machine learning engine may be utilized by the resource aggregation and deployment application 312 to monitor and process received data for resource deployment decisioning.

In some embodiments, the memory device 306 includes data storage 308 for storing data related to the system environment, but not limited to data created and/or used by the resource aggregation and deployment application 312 and the artificial intelligence application and machine learning engine 314, such as a historical interaction database 316, user profile database 318, and resource deployment database 320.

The historical interaction database 316 is used to store information regarding past interactions (e.g., account actions, transactions, communications, inputs) with the user 102. In some embodiments, the historical interaction database 316 may be configured to store data from an incoming data stream in real-time. The user profile database 318 is used to store user profiles generated by the system from the collected user data and information (e.g., historical data, resource data, and the like). The system may be configured to access and update the stored user profiles from the user profile database 318 as additional information is collected. The resource deployment database 320 is used for storing aggregated resources and calculated resource deployment options as determined by the system. In one embodiment, the system continuously updates the resource deployment options based on continued or subsequent user interactions and data collected by the system.

In one embodiment of the invention, the resource aggregation and deployment engine 130 may associate with applications having computer-executable program code that instruct the processing device 304 to perform certain functions described herein. In one embodiment, the computer-executable program code of an application associated with the user device 110 and/or the entity system 120 may also instruct the processing device 304 to perform certain logic, data processing, and data storing functions of the application. In one embodiment, the resource aggregation and deployment engine 130 further comprises a dynamic optimization algorithm to be executed by the processing device 304 or a controller for calibrating or tuning resource deployment options from large collections of available resources and resource locations. The dynamic optimization algorithm may further be updated with new information associated with current user decisions, wherein the new information may be continuously injected back into the optimization algorithm in response to real-time decisioning.

Embodiments of the resource aggregation and deployment engine 130 may include multiple systems, servers, computers or the like maintained by one or many entities. In some embodiments, the resource aggregation and deployment engine 130 may be part of the entity system 120. In other embodiments, the entity system 120 is distinct from the resource aggregation and deployment engine system 130. The resource aggregation and deployment engine 130 may communicate with the entity system 120 via a secure connection generated for secure encrypted communications between the two systems either over the network 101 or alternative to the network 101.

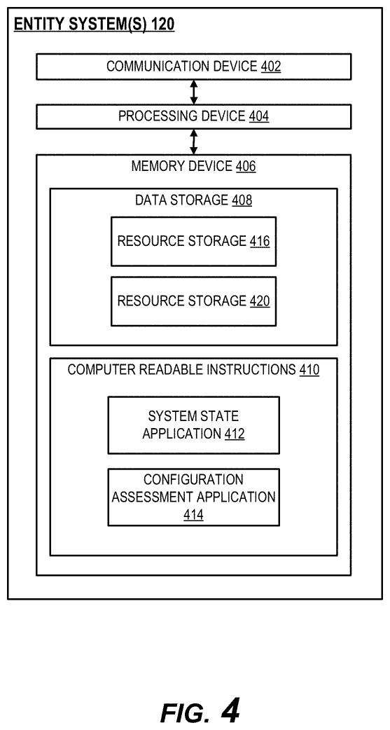

FIG. 4 provides a block diagram of a resource aggregation and deployment engine or system 130, in accordance with one embodiment of the invention. The resource aggregation and deployment engine 130 generally comprises a controller 301, a communication device 302, a processing device 304, and a memory device 306.

As used herein, the term “controller” generally refers to a hardware device and/or software program that controls and manages the various systems described herein such as the user device 110, the entity system 120, and/or the resource aggregation and deployment engine 130, in order to interface and manage data flow between systems while executing commands to control the systems. In some embodiments, the controller may be integrated into one or more of the systems described herein. In some embodiments, the controller may perform one or more of the processes, actions, or commands described herein.

As used herein, the term “processing device” or “processor” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 304 is operatively coupled to the communication device 302 and the memory device 306. The processing device 304 uses the communication device 302 to communicate with the network 101 and other devices on the network 101, such as, but not limited to the user device 110 and the entity system 120. As such, the communication device 302 generally comprises a modem, server, or other device for communicating with other devices on the network 101.

As further illustrated in FIG. 3, the resource aggregation and deployment engine 130 comprises computer-readable instructions 310 stored in the memory device 306, which in one embodiment includes the computer-readable instructions 310 of a resource aggregation and deployment application 312 and an artificial intelligence application 314 which further comprises a machine learning engine. In one embodiment, the artificial intelligence application 322 and machine learning engine may be utilized by the resource aggregation and deployment application 312 to monitor and process received data for resource deployment decisioning.

In some embodiments, the memory device 306 includes data storage 308 for storing data related to the system environment, but not limited to data created and/or used by the resource aggregation and deployment application 312 and the artificial intelligence application and machine learning engine 314, such as a historical interaction database 316, user profile database 318, and resource deployment database 320.

The historical interaction database 316 is used to store information regarding past interactions (e.g., account actions, transactions, communications, inputs) with the user 102. In some embodiments, the historical interaction database 316 may be configured to store data from an incoming data stream in real-time. The user profile database 318 is used to store user profiles generated by the system from the collected user data and information (e.g., historical data, resource data, and the like). The system may be configured to access and update the stored user profiles from the user profile database 318 as additional information is collected. The resource deployment database 320 is used for storing aggregated resources and calculated resource deployment options as determined by the system. In one embodiment, the system continuously updates the resource deployment options based on continued or subsequent user interactions and data collected by the system.

In one embodiment of the invention, the resource aggregation and deployment engine 130 may associate with applications having computer-executable program code that instruct the processing device 304 to perform certain functions described herein. In one embodiment, the computer-executable program code of an application associated with the user device 110 and/or the entity system 120 may also instruct the processing device 304 to perform certain logic, data processing, and data storing functions of the application. In one embodiment, the resource aggregation and deployment engine 130 further comprises a dynamic optimization algorithm to be executed by the processing device 304 or a controller for calibrating or tuning resource deployment options from large collections of available resources and resource locations. The dynamic optimization algorithm may further be updated with new information associated with current user decisions, wherein the new information may be continuously injected back into the optimization algorithm in response to real-time decisioning.

As illustrated in detail in FIG. 4, the environment 100 further includes one or more entity systems 120 which are connected to the user device 110 and the resource aggregation and deployment system 130. The entity systems may be associated with one or more entities, institutions or the like. The entity system 120 generally comprises a communication device 402, a processing device 404, and a memory device 406 further comprising data storage 408. The entity system 120 comprises computer-readable instructions 410 stored in the memory device 406, which in one embodiment includes the computer-readable instructions of an entity application 412 and a rewards application 414. The entity system 120 may communicate with the user device 110 and the resource aggregation and deployment engine 130 to provide access to one or more resource locations stored and maintained on the entity system 120. In some embodiments, the entity system 120 may communicate with resource aggregation and deployment engine 130 during an interaction with a user 102 in real-time, wherein user interactions may be monitored and processed by the resource aggregation and deployment engine 130.

In some embodiments, the resource aggregation and deployment engine 130 may be configured to analyze and process complex, multi-faceted interactions. Multi-faceted interactions are interactions potentially requiring deployment of a combination of resources in order to meet the requirements of the interaction, the deployment of the combination of resources comprising layers of interconnected resources operating in unison. As the various resource layers may be combined in a number of ways, the complexity of determining an optimal solution (e.g., maxima or minima) increases with the inclusion of additional variables (i.e., available resource options). The resource aggregation and deployment engine 130 as described herein may be configured to analyze and process the various resource layers and connections present in a multi-faceted interaction. Furthermore, the system may be configured to configure or tune deployment of the user resources in order to optimize resource potential (e.g., value) and/or provide an array of options for completing a multi-faceted interaction. In some embodiments, the system may leverage artificial intelligence and machine learning technology to analyze multivariable data in real-time and provide an assortment of determined resource deployments for a collection of user resources.

In a specific example, a multi-faceted interaction may comprise a user scheduling a trip or vacation, wherein the user desires to reserve or plan for air travel, lodging, transportation (e.g., rental car), dining, entertainment, and the like using a variety of resources (e.g., a combination of different credit cards each having different structured rewards systems). The resource aggregation and deployment engine 130 may be configured to aggregate the various resources of the user and calculate a deployment of the user resources that may, for example, maximize earned rewards, minimize costs, and/or meet custom user-specified conditions a custom (e.g., a combination of maximizing rewards and minimizing costs).

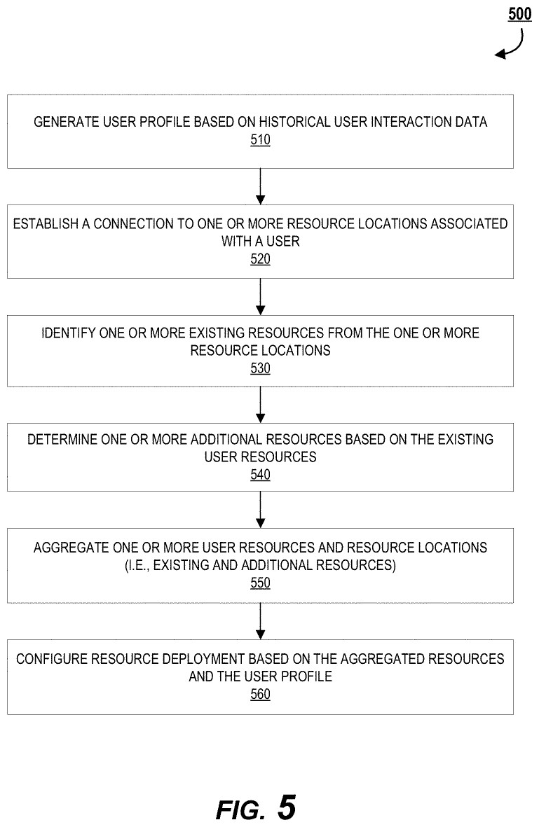

FIG. 5 provides a high level process flow illustrating resource aggregation and deployment, in accordance with one embodiment of the invention. As illustrated in block 510, the system generates a user profile based on user interaction data and/or other user information. User information may be collected by the system either directly from the user by the resource aggregation and deployment engine 130 and/or indirectly from an entity system 120 with which the user maintains a relationship (e.g., maintains an account or other resource location). The user information and/or interaction data may comprise historical data and/or real-time data collected continuously by the system as interactions occur. For example, real-time data collection may include collecting information associated with a user transaction in real-time as the transaction is occurring or shortly thereafter, wherein a user profile may be updated to immediately reflect the recent transaction.

In some embodiments, collected user information may include user identifying information, communication history, interaction information, and the like. Data, such as user interaction data or information, may be acquired from across communication channels such as phone lines, text messaging systems, email, applications (e.g., mobile applications), websites, ATMs, card readers, call centers, electronic assistants, instant messaging systems, interactive voice response (IVR) systems, brick-and-mortar locations and the like. In some embodiments, the system may be configured to identify and collect data associated with intended or predicted interactions as indicated by user actions, communications, and/or trends identified as being typical of the user. The system may identify the predicted interaction as an upcoming or pending interaction allowing for pre-processing and preemptive decisioning for the interaction by the resource aggregation and deployment engine 130. In some embodiments, the interaction information stored in the user profile may include complex or multi-faceted interactions.

As illustrated in block 520, the system establishes a connection to one or more resource locations associated with the user. The one or more resource locations may be further associated with one or more entity systems 120. For example, the resource location may be associated with the user but stored and maintained on an entity system. A variety of resource locations may be held across several, disparate entity systems (e.g., third-party entity systems), wherein the system described herein connects with the disparate systems to provide a unified platform and holistic view for managing all connected user resources for collective resource decisioning and deployment. In one embodiment, the system requires authorization from a user to establish the connection. The user may be prompted to provide authentication information to authorize access by the system to a resource location associated with the user.

Using the established connection, the system identifies one or more existing resources from the one or more resource locations associated with the user, as illustrated in block 530. An existing resource comprises any resource known and/or used by the user for completing interactions. In one embodiment, an existing resource is a resource that is actively used by the user to complete interactions. In some embodiments, an existing resource may be a resource that is inefficiently utilized or neglected by a user. For example, an existing resource may be an inactive or temporarily suspended resource associated with the user. Existing resources may further comprise any supplemental resources associated with an existing resource. For example, a supplemental resource may include rewards points accrued for using an existing resource such as a credit card to complete interactions. Existing resources may further be identified from the user information such as in historical interaction data, wherein an existing resource was used to complete a past interaction.

Additionally, the system is further configured to determine one or more additional resources as illustrated in block 540. An additional resource is a new resource that is not currently associated with a user but is available for association with the user. In a specific example, an additional resource may comprise a new credit card that a user is eligible to receive through enrollment. In some embodiments, the system may determine an additional resource based on the existing user resources by determine similar or complementary additional resource to existing resources. In another embodiment, the system may determine additional resources from the one or more entity systems. In another specific example, the system may pull or extract information related to potential additional resources for which a user is eligible from a third-party entity system. Additional resources may further comprise any supplemental resources associated with an additional resource such as the potential for earning reward points and enrollment bonuses. In some embodiments, the system may be configured to automatically enroll a user in one or more additional resources.

As illustrated in block 550, the system aggregates the one or more user resources and resource locations. Aggregation of the user resources may include both existing resources and additional resource identified by the system, wherein all resources identified by the system across the connections with various entity systems are viewable together. The system is able to configure a resource deployment based on the aggregated resources and the user profile as illustrated in block 560. Configuration of a resource deployment comprises analyzing and processing the aggregated resources (i.e., existing, additional, supplemental) along with the generated user profile to determine or calculate a particular deployment of the resources for completing an interaction based on a desired outcome of the interaction by the user.

In one embodiment, the system may determine an optimal solution (e.g., maxima or minima) for deploying user resources. In another embodiment, the system may be configured to configure or fine-tune deployment of the user resources to optimize resource potential (e.g., value). For example, the system may be configured to aggregate the various resources of the user and calculate a deployment of the user resources that may, for example, maximize rewards earned, minimize costs, and/or meet custom user-specified conditions (e.g., a combination of maximizing rewards and minimizing costs). In another embodiment, the system may calculate and provide an array of options for completing an interaction, wherein the system is configured to present the user with the array of options via user interface. The user may input a selected option with which to complete an interaction.

In one embodiment, the system is configured for determining one or more deployments for a multi-faceted interaction. In some embodiments, the system leverages artificial intelligence and machine learning technology for configuring a complex multivariable resource deployment.

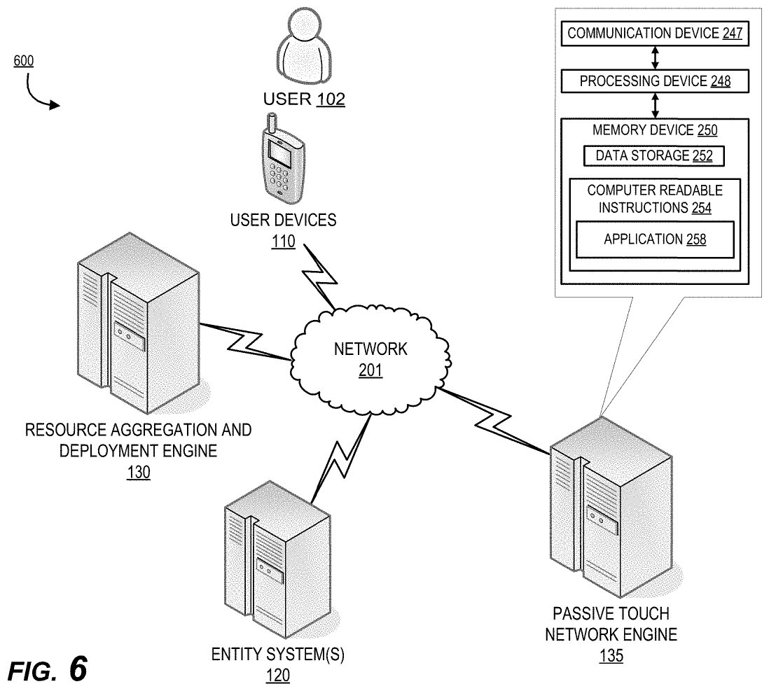

FIG. 6 provides an intelligent passive touch resource network engine integration within a resource aggregation and deployment system environment 600, in accordance with an embodiment of the invention. It will be appreciated that in other embodiments, one or more of the systems, devices, or servers may be combined into a single system, device, or server, or be made up of multiple systems, devices, or servers. It should be understood that the servers, systems, and devices described herein illustrate one embodiment of the invention. It is further understood that one or more of the servers, systems, and devices can be combined in other embodiments and still function in the same or similar way as the embodiments described herein.

The network 201, user devices 110, resource aggregation and deployment engine 130, and entity systems 120 have been described in further detail above. The system environment 600 may also include a passive touch network engine 135. FIG. 6 provides the system environment 600 for which the distributive network system with specialized data feeds associated with passive touch resource analysis for misappropriation prevention. FIG. 6 provides a unique system that includes specialized servers and system communicably linked across a distributive network of nodes required to perform the functions described herein.

As illustrated in FIG. 6, the passive touch network engine 135 is operatively coupled, via a network 201 to the user devices 110, resource aggregation and deployment engine 130, and entity systems 120.

In this way, the passive touch network engine 135 can send information to and receive information from the user devices 110, resource aggregation and deployment engine 130, and entity systems 120. FIG. 6 illustrates only one example of an embodiment of the system environment 600, and it will be appreciated that in other embodiments one or more of the systems, devices, or servers may be combined into a single system, device, or server, or be made up of multiple systems, devices, or servers.

As illustrated in FIG. 6, the passive touch network engine 135 generally comprises a communication device 247, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 247 and the memory device 250. The processing device 248 uses the communication device 247 to communicate with the network 201 and other devices on the network 201, such as, but not limited to the user devices 110, resource aggregation and deployment engine 130, and entity systems 120. As such, the communication device 247 generally comprises a modem, server, or other device for communicating with other devices on the network 201.

As further illustrated in FIG. 6, the passive touch network engine 135 comprises computer-readable instructions 254 stored in the memory device 250, which in one embodiment includes the computer-readable instructions 254 of an application 258. In some embodiments, the memory device 250 includes data storage 252 for storing data related to the system environment 200, but not limited to data created and/or used by the application 258. The application 258 associated with the passive touch network engine 135 may utilize a multi-faceted resource decisioning machine learning application integration as data deployment across a built out passive touch network engine for deployment and integration for passive touch misappropriation identification. The passive touch network performs artificial intelligent pattern trends, locations, usages, and the like to determine potential misappropriation via supplemental resource. This is a deviation from standard data based misappropriation prevention based on utilization of supplemental resources as misappropriation predictors, as such, identifying third party benefits or programs and use that as a non-monitory misappropriation predictor.

In one embodiment of the passive touch network engine 135 the memory device 250 stores an application 258. In one embodiment of the invention, the application 258 may associate with applications having computer-executable program code. Furthermore, the passive touch network engine 135, using the processing device 248 codes certain communication functions described herein. In one embodiment, the computer-executable program code of an application associated with the application 258 may also instruct the processing device 248 to perform certain logic, data processing, and data storing functions of the application. The processing device 248 is configured to use the communication device 247 to communicate with and ascertain data from one or more servers associated with the network.

It is understood that the servers, systems, and devices described herein illustrate one embodiment of the invention. It is further understood that one or more of the servers, systems, and devices can be combined in other embodiments and still function in the same or similar way as the embodiments described herein.

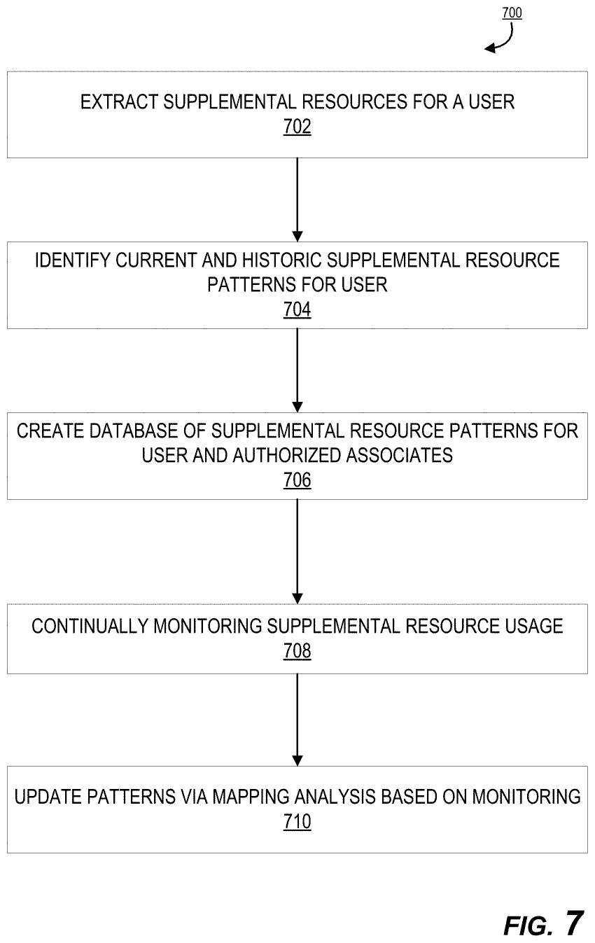

FIG. 7 provides a high level process flow illustrating network engine deployment for passive touch resource analysis 700, in accordance with one embodiment of the invention. As illustrated in block 702, the process 700 is initiated by extracting the supplement resource data for a user. This data may be extracted from the data gathered and processed by the resource aggregation and deployment engine described in more detail above. The data may include any supplemental resource usages associated with the user. These may include subscriptions, promotions, rewards, points, loyalty programs, or the like. In this way, the passive touch network engine may communicate with the resource aggregation and deployment engine across the network in order to obtain user specific supplemental resource data compiled and processed by the resource aggregation and deployment engine.

Next, as illustrated in block 704, the process 700 continues by identifying current and historic supplemental resource patterns for the user. In this way, the system performs artificial intelligent and machine learning processes on the supplemental resource uses of the user to identify patterns in user supplemental resource usage. For example, the system may identify the user signing into a subscription service from a first geographical location during a week day and a second geographical location during a weekend. Using this example, the system may identify known geographical locations of the user based on a day of the week. Furthermore, the system may be able to identify the user accessing a promotion or subscription from a third geographical location to identify that the user may be traveling or outside his/her normal pattern.

Next, as illustrated in block 706, the process 700 continues by creating a database of the supplemental resource patterns identified for the user and the user's authorized associates, such as family members or the like. The database may identify normal patterning of user usage of supplemental resources based on usage, geographic location, time, and the like. As such, the system learns user tendencies and locations based on the supplemental resources the user utilizes. The supplemental resource usage of the user and authorized associates may be continually monitored, as illustrated in block 708. Finally, as illustrated in block 710, the process 700 is completed by updating the user patterns using mapping analysis based on the monitoring of supplemental resource usage.

In some embodiments, the system may identify a geographic location of a user based on supplemental resource usages, such as usage of subscriptions, on-line log-ins, or the like, such as logging into an internet subscription, television, gym, membership location, or the like. As such, the system may identify the location and, upon identification of a transaction at the location associate with the supplemental resource usage and allow the transaction to occur based on the same.

In some embodiments, the system may provide signal data throughout a travel experience for a user. In this way, the system may identify booking, checking in, making changes, and end of travel. In this way, the system may identify when a user is at a geographic location and allow for the processing of transactions at that location.

Furthermore, the system may identify locations of the user and/or if the user is in a position to perform a transaction. For example, a user may be using a mapping application for driving. The system may identify that the user may not be in a position to be performing a transaction because he/she may be driving. As such, if a transaction does occur at that time, the system may require authentication of the transaction for completion.

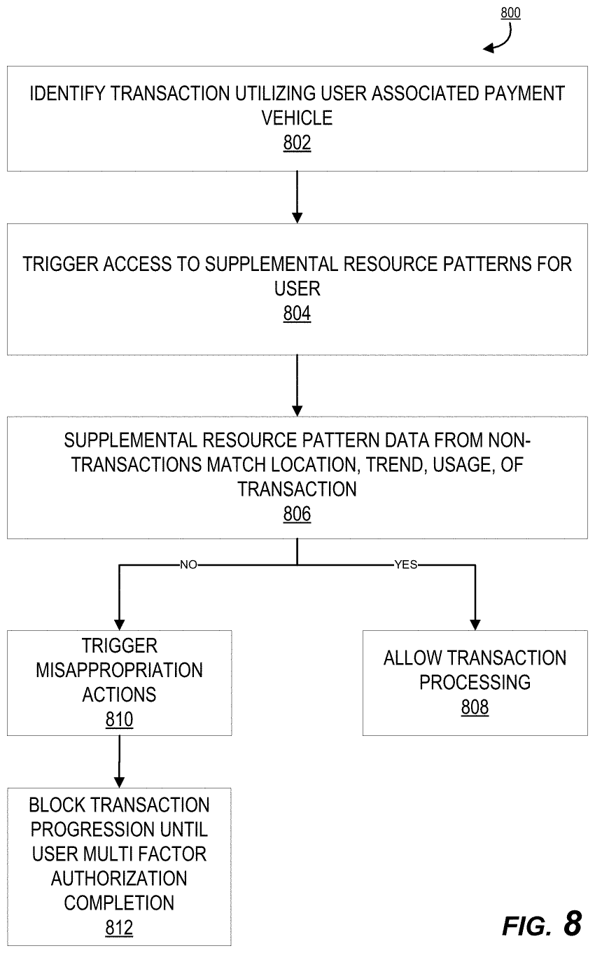

FIG. 8 provides a high level process flow illustrating passive touch resource analysis and misappropriation identification 800, in accordance with one embodiment of the invention. As illustrated in block 802, the process 800 is initiated upon identification of a transaction being performed using a user associated payment vehicle. This transaction may be performed by the user, an authorized individual, or via misappropriation. The transaction may trigger system access to the supplemental resource patterns for the user on the database, as illustrated in block 804.

Next, as illustrate in block 806, the process 800 continues by determining if the supplemental resource pattern data from the non-transactions via the database match a location, trend, usage or the like of the transaction. In this way, the system may be able to identify a same geographic location of a transaction and a supplemental resource usage of a user during that same day or timeframe. Thus, providing an indication of an authentic transaction being conducted. As such, if the supplemental resource patterning data matches a location, trend, use, or timeframe of the current transaction, the system may communicate with the merchant and transaction provider to provide authorization for the transaction and allow for transaction processing, as illustrated in block 808.

However, if the supplemental resource patterning data does not match the location, trend, usage, timing, or the like of the current transaction, the system may trigger a misappropriation action for the transaction, as illustrated in block 810. Upon supplemental resource patterning not matching the transaction, the system may transmit a blockage of the transaction progression until the user provides a multi-factor authentication completion for approving the transaction if the transaction was in fact authenticated by the user and not a misappropriation, as illustrated in block 812.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function. As such, once the software and/or hardware of the claimed invention is implemented the computer device and application-specific circuits associated therewith are deemed specialized computer devices capable of improving technology associated with the in authorization and instant integration of a new credit card to digital wallets.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a special purpose computer for the authorization and instant integration of credit cards to a digital wallet, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

### INCORPORATION BY REFERENCE

To supplement the present disclosure, this application further incorporates entirely by reference the following commonly assigned patent applications:

| | U.S. patent | | |
|---|---|---|---|
| Docket Number | application Ser. No. | Title | Filed On |
| 9005US1.014033.3431 | To be assigned | MULTI-FACETED | Filed |
| | | RESOURCE | Concurrently |
| | | AGGREGATION | Herewith |
| | | ENGINE FOR LINKING | |
| | | EXTERNAL SYSTEMS | |
| 9006US1.014033.3432 | To be assigned | NETWORK ENGINE | Filed |
| | | FOR INTELLIGENT | Concurrently |
| | | MULTI-FACETED | Herewith |
| | | RESOURCE ANALYSIS | |

What is claimed is:

1. A system for intelligent passive touch authentication, the system comprising:
a memory device with computer-readable program code stored thereon;
a communication device;
a processing device operatively coupled to the memory device and the communication device, wherein the processing device is configured to execute the computer-readable program code to:
identify supplemental resources associated with a user;
identify, via artificial intelligence engine analysis, supplemental resource patterns for the user;
monitor, continually, user supplemental resource usage and update the supplemental resource usage based on the monitoring;
trigger accessing the supplemental resource patterns based on an identification of a transaction utilizing a vehicle associated with the user;
compare the supplemental resource pattern data with the transaction utilizing the vehicle associated with the user;
trigger misappropriation action based on no match between geographic location associated with the supplemental resource pattern data and the transaction utilizing the vehicle associated with the user; and
block the transaction and processing the transaction until additional user multi-factor authentication completion.

2. The system of claim 1, further comprising allowing transaction processing based on a match between the supplemental resource pattern data and the transaction utilizing the vehicle associated with the user.

3. The system of claim 1, wherein comparing the supplemental resource pattern data with the transaction utilizing the vehicle associated with the user further comprising identifying a geographical location match between the supplemental resource pattern data and the transaction.

4. The system of claim 1, wherein comparing the supplemental resource pattern data with the transaction utilizing the vehicle associated with the user further comprises comparing a geographic location, trend, or usage of the supplemental resources with the transaction.

5. The system of claim 1, further comprising creating a database of supplemental resource patterns for the user and user authorized associates.

6. The system of claim 1, wherein the supplemental resource patterns for the user further comprise locations, times, trends, and usage of the supplemental resources for the user.

7. The system of claim 1, wherein supplemental resources further comprise third party benefits, programs, and subscriptions available to the user including points, rewards, offers, subscription services, products, services associated with non-monetary benefits.

8. The system of claim 1, wherein identifying transaction utilizing vehicle associated with the user further comprises transactions using a payment vehicle associated with the user by the user, an authorized associate of the user, or a misappropriation of the payment vehicle.

9. A computer program product for intelligent passive touch authentication, the computer program product comprising at least one non-transitory computer-readable medium having computer-readable program code portions embodied therein, the computer-readable program code portions comprising:
an executable portion configured for identifying supplemental resources associated with a user;
an executable portion configured for identifying, via artificial intelligence engine analysis, supplemental resource patterns for the user;
an executable portion configured for monitoring, continually, user supplemental resource usage and update the supplemental resource usage based on the monitoring;
an executable portion configured for triggering accessing the supplemental resource patterns based on an identification of a transaction utilizing a vehicle associated with the user;
an executable portion configured for comparing the supplemental resource pattern data with the transaction utilizing the vehicle associated with the user;
an executable portion configured for triggering misappropriation action based on no match between geographic location associated with the supplemental resource pattern data and the transaction utilizing the vehicle associated with the user; and
an executable portion configured for blocking the transaction and processing the transaction until additional user multi-factor authentication completion.

10. The computer program product of claim 9, further comprising an executable portion configured for allowing transaction processing based on a match between the supplemental resource pattern data and the transaction utilizing the vehicle associated with the user.

11. The computer program product of claim 9, wherein comparing the supplemental resource pattern data with the transaction utilizing the vehicle associated with the user further comprising identifying a geographical location match between the supplemental resource pattern data and the transaction.

12. The computer program product of claim 9, wherein comparing the supplemental resource pattern data with the transaction utilizing the vehicle associated with the user further comprises comparing a geographic location, trend, or usage of the supplemental resources with the transaction.

13. The computer program product of claim 9, further comprising an executable portion configured for creating a database of supplemental resource patterns for the user and user authorized associates.

14. The computer program product of claim 9, wherein the supplemental resource patterns for the user further comprise locations, times, trends, and usage of the supplemental resources for the user.

15. The computer program product of claim 9, wherein supplemental resources further comprise third party benefits, programs, and subscriptions available to the user including points, rewards, offers, subscription services, products, services associated with non-monetary benefits.

16. The computer program product of claim 9, wherein identifying transaction utilizing vehicle associated with the user further comprises transactions using a payment vehicle associated with the user by the user, an authorized associate of the user, or a misappropriation of the payment vehicle.

17. A computer-implemented method for intelligent passive touch authentication, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
identifying supplemental resources associated with a user;
identifying, via artificial intelligence engine analysis, supplemental resource patterns for the user;
monitoring, continually, user supplemental resource usage and update the supplemental resource usage based on the monitoring;
triggering accessing the supplemental resource patterns based on an identification of a transaction utilizing a vehicle associated with the user;
comparing the supplemental resource pattern data with the transaction utilizing the vehicle associated with the user;
triggering misappropriation action based on no match between geographic location associated with the supplemental resource pattern data and the transaction utilizing the vehicle associated with the user; and
blocking the transaction and processing the transaction until additional user multi-factor authentication completion.

18. The computer-implemented method of claim 17, further comprising allowing transaction processing based on a match between the supplemental resource pattern data and the transaction utilizing the vehicle associated with the user.

19. The computer-implemented method of claim 17, wherein comparing the supplemental resource pattern data with the transaction utilizing the vehicle associated with the user further comprising identifying a geographical location match between the supplemental resource pattern data and the transaction.

20. The computer-implemented method of claim 17, wherein comparing the supplemental resource pattern data with the transaction utilizing the vehicle associated with the user further comprises comparing a geographic location, trend, or usage of the supplemental resources with the transaction.
